(19) United States
(12) Patent Application Publication
(10) Pub. No.: US 2021/0107224 A1
(43) Pub. Date: Apr. 15, 2021

(54) BUILD MODULE WITH DEFORMABLE WALL

(71) Applicant: HEWLETT-PACKARD DEVELOPMENT COMPANY, L.P., Spring, TX (US)

(72) Inventor: Timothy A. Dummer, Vancouver, WA (US)

(21) Appl. No.: 16/981,912

(22) PCT Filed: Jul. 27, 2018
(86) PCT No.: PCT/US2018/044015

§ 371 Date: Sep. 17, 2020

(51) Int. Cl. B29C 64/255; B29C 64/153; B22F 10/28; B22F 12/30; B33Y 10/00; B33Y 30/00

(52) U.S. Cl. CPC B29C 64/255; B29C 64/153; B33Y 30/00; B22F 12/30; B33Y 10/00; B22F 10/28

(57) ABSTRACT

In some examples, a build module for an additive manufacturing machine includes a deformable wall defining a build chamber for receiving build material during a build operation, and pressure application members arranged around the deformable wall and in contact with a plurality of points of the deformable wall, the pressure application members to deform the deformable wall by applying lateral forces against the deformable wall.

### BACKGROUND

Additive manufacturing machines produce three-dimensional (3D) objects by building up layers of material. A type of an additive manufacturing machine is referred to as a 3D printing system. Additive manufacturing machines are able to receive as input a computer aided design (CAD) model or other digital representation of a physical 3D object to be formed, and build, based on the CAD model, the physical 3D object. The model may be processed into layers by the additive manufacturing machine, and each layer defines a corresponding part (or parts) of the 3D object.

### BRIEF DESCRIPTION OF THE DRAWINGS

Some implementations of the present disclosure are described with respect to the following figures.

FIG. 1 is a schematic diagram of an additive manufacturing machine including a build module according to some examples.

FIG. 2 is a top view of a build module that includes a deformable wall and pressure application rods according to some examples.

FIG. 3 is a side view of a build module including a deformable wall and pressure application rods according to some examples.

FIGS. 4A-4D are top views of build modules in various configurations corresponding to different geometric shapes formed by deforming a deformable wall using pressure application rods, according to various examples.

FIG. 5 is a side view of an assembly that includes a platform base, a release mechanism, a mounting cap, and a build plate, according to some examples.

FIG. 6 is a top view of an assembly that includes a build module and a mounting cap, according to some examples.

FIG. 7 is a block diagram of an additive manufacturing machine according to some examples.

FIG. 8 is a flow diagram of a process of forming a build module according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

An additive manufacturing machine such as a three-dimensional (3D) printing system can build 3D objects by forming successive layers of build material and processing each layer of build material on a build platform. In some examples, a build material can include a powdered build material that is composed of particles in the form of fine powder or granules. The powdered build material can include metal particles, plastic particles, polymer particles, ceramic particles, or particles of other powder-like materials. In some examples, a build material powder may be formed from, or may include, short fibers that may, for example, have been cut into short lengths from long strands or threads of material.

As part of the processing of each layer of build material, agents can be dispensed (such as through a printhead or other liquid delivery mechanism) to the layer of build material. Examples of agents include a fusing agent (which is a form of an energy absorbing agent) that absorbs the heat energy emitted from an energy source used in the additive manufacturing process. For example, after a layer of build material is deposited onto a build platform (or onto a previously formed layer of build material) in the additive manufacturing machine, a fusing agent with a target pattern can be deposited on the layer of build material. The target pattern can be based on an object model (or more generally, a digital representation) of the physical 3D object that is to be built by the additive manufacturing machine.

According to an example, a fusing agent may be an ink-type formulation including carbon black, such as, for example, the fusing agent formulation commercially referred to as the V1Q60Q “HP fusing agent” available from HP Inc. In an example, a fusing agent may additionally include an infrared light absorber, a near infrared light absorber, a visible light absorber, or an ultraviolet (UV) light absorber. Fusing agents can also refer to a chemical binding agent, such as used in a metal 3D printing system. In further examples, other types of additive manufacturing agents can be added to a layer of build material.

Following the application of the fusing agent, an energy source (e.g., including a heating lamp or multiple heating lamps that emit(s) energy) is activated to sinter, melt, fuse, bind, or otherwise coalesce the powder of the layer of build material underneath the fusing agent. The patterned build material layer (i.e., portions of the layer on which the fusing agent was deposited) can solidify and form a part, or a cross-section, of the physical 3D object.

Next, a new layer of powder is deposited on top of the previously formed layer, and the process is re-iterated in the next additive manufacturing cycle to form 3D parts in the successive layers of build material. The 3D parts collectively form a 3D object (or multiple 3D objects) that is the target of the build operation.

The building of a 3D object (or 3D objects) in successive layers occurs in a build module (also referred to as a “build bucket”) of the additive manufacturing machine. A “build module” or “build bucket” refers generally to a chamber defined by a wall (or walls) in which a build material is provided along with agents for defining 3D parts. In some examples, build modules of additive manufacturing machines are formed with rigid walls, such as rigid walls that form a rectangular chamber. In such examples, the rigid walls of the build module can be welded or otherwise attached together. Generally, the dimensions of such build modules are fixed. During a build operation, various factors may cause the build material in a build module to lose contact with the rigid walls of the build module. Such factors can include any or some combination of the following: expansion and contraction of the build material caused by application and removal of heat, due to heat convection, conduction, and/or radiation; changes in properties of build material due to build processes; formation of parts of different shapes and sizes; and so forth.

As a result of the build module walls being unable to maintain consistent contact with the build material during a build operation, forces applied to the build material at the edges of each layer of build material can vary at different stages of the build operation. This can cause parts at the edges of a build material layer to break apart more easily. Moreover, due to the lack of consistent or appropriate force applied by the walls of the build module against the build material layer, build material powder can overlap over each other due to build material displacement caused by heat and other processes.

As a result, parts formed near the walls of the build module may exhibit poor yield, which reduces overall efficiency in 3D objects formed by an additive manufacturing machine.

Additionally, the fixed size of a build module formed with rigid walls can lead to either inefficient building of a target 3D object that is much smaller than the volume of the build module, or an inability to build a target 3D object having a size that exceeds the volume of the build module. The “volume” of the build module refers to the volume available to receive the layers of build material to form the target 3D object in the build module.

If the target 3D object being formed is much smaller than the volume of the build module, then a large proportion of the build material dispensed into the build module may not be used to form the target 3D object, which can lead to increased build material waste if the excess build material cannot be recycled for use in the next build cycle.

On the other hand, if the target 3D object is too large (i.e., larger than the volume of the build module), then the additive manufacturing machine would not be useable in forming the target 3D object.

In accordance with some implementations of the present disclosure, a build module for an additive manufacturing machine includes a deformable wall defining a build chamber for receiving build material during a build operation, and pressure application members arranged around the deformable wall and in contact with a plurality of points of the deformable wall, the pressure application members to deform the deformable wall by applying side forces against the deformable wall.

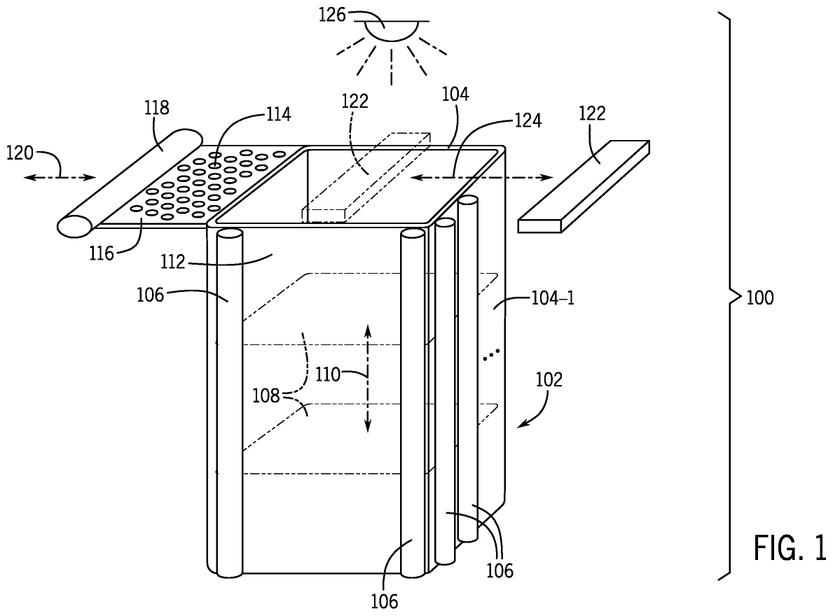

FIG. 1 is a schematic diagram of an additive manufacturing machine 100 that includes a build module 102 according to some implementations of the present disclosure. The build module 102 includes a deformable wall 104 and pressure application rods 106. The deformable wall 104 can be deformed based on application of lateral forces against the side outer surfaces 104-1 of the deformable wall 104 by pressure application rods 106. Just some of the pressure application rods 106 are depicted in FIG. 1 for better clarity.

Although reference is made to pressure application rods in the discussion of some examples of the present disclosure, it is noted that in other examples, other types of pressure application numbers can be employed. A “rod” can refer to an elongated bar, which in some examples can include a tubing and in other examples can include a solid cylinder. In some examples, each pressure application rod 106 can have a circular or oval cross section. In other examples, pressure application members can have different cross-sectional shapes.

Each of the deformable wall 104 and pressure application rods 106 can be formed of a metal. For example, the deformable wall 104 can be formed of a stainless steel or some other metal. In some specific examples, the deformable wall 104 can be a hollow wall, including an outer housing and a hollow chamber within the other housing.

The deformable wall 104 can be formed of a single seamless non-welded construction, where the deformable wall 104 (at least initially) extends around the circumference in a continuous fashion without breaks. In some examples, the deformable wall 104 is formed using a cylindrical extrusion process, in which the material of the deformable wall 104 is pushed around a die of the target cross-sectional shape (e.g., square, rectangle, circle, oval, and so forth).

The pressure application rods 106 can also be formed of a stainless steel or other metal. In further examples, instead of forming the deformable wall 104 and/or the pressure application rods 106 using metal, the deformable wall 104 and/or pressure application rods 106 can be formed using other types of materials.

As shown in FIG. 1, a build plate 108 is moveable along an axis 110 that is parallel to a longitudinal axis of the build module 102. A “build plate” refers to any support structure onto which build material can be dispensed and processed in the build module 102.

A workspace 112 is defined above the build plate 108, where the workspace 112 is the space in which a build cycle can be performed. A build cycle refers to a cycle in which a layer of build material is dispensed into the workspace 112, initially onto the build plate 108 and subsequently onto previously processed build material layer(s), followed by application of an agent (or multiple agents) for the processing of the build material layer in the workspace 112. As layers of build material are formed in successive build cycles, the build plate 108 can be incrementally lowered along the axis 110 in the build module 102 to allow for a further layer of build material to be deposited into the workspace 112.

As shown in FIG. 1, a build material 114 (formed of a powder, for example) is provided on a dispensing surface 116. A spreader 118 is moveable along an axis 120. The spreader 118 can be moved along the axis 120 toward the build module 102 to cause spreading of the build material 114 into the workspace 112 of the build module 102. The spreader 118 can include a roller, a blade, or any other type of material spreading device. Initially, when the workspace 112 is empty, the build material 114 is dispensed by the spreader 118 onto the build plate 108. After the initial build cycle, successive layers of the build material 114 are spread by the spreader 118 onto previously processed layer(s) of build material in the workspace 112.

The additive manufacturing machine 100 further includes an agent dispenser 122, which is moveable along an axis 124. Although FIG. 1 shows the axis 124 as being parallel to the axis 120 (along which the spreader 118 is moveable), in other examples, the axis 124 can extend in a different direction from that of the axis 120. If the additive manufacturing machine 100 is a 3D printing system, then the agent dispenser 122 can be referred to as a printhead.

The agent dispenser 122 includes an array of liquid ejection nozzles to deliver an agent (or multiple agents) onto a layer of build material in the workspace 112. As shown in FIG. 1, the agent dispenser 122 has been moved from an initial position to a position (in dashed profile) over the workspace 112, at which point the agent dispenser 122 can be activated (by a controller, not shown) to cause dispensing of an agent (or multiple agents).

In some examples, the agent dispenser 122 is as wide as a width or other dimension of the workspace 112. In different examples, the agent dispenser 122 can extend by a width that is less than the width or other dimension of the workspace 112, in which case the agent dispenser 122 would be moveable along the axis 124 as well as along a different horizontal axis that is perpendicular to the axis 124.

The additive manufacturing machine 100 further includes an energy source 126, which when activated (such as by the controller, not shown) applies heat to the workspace 112. The heat applied by the energy source 126 allows for heating of a layer of build material. For example, if a fusing agent is applied by the agent dispenser 122, then the heat applied by the energy source 126 can cause fusing of portions of the layer of build material based on where the fusing agent was dispensed. The fusing agent absorbs heat from the energy source 126, which causes an increase in temperature of portions of the layer of build material underneath the fusing agent to cause melting, sintering, or coalescence of the powder of the layer of build material that is being processed. The energy source 126 can be implemented using any of various different types of energy sources, such as a lamp or light emitting diodes (LEDs) to emit infrared, near infrared, ultraviolet, or visible light, or as lasers with specific wavelengths.

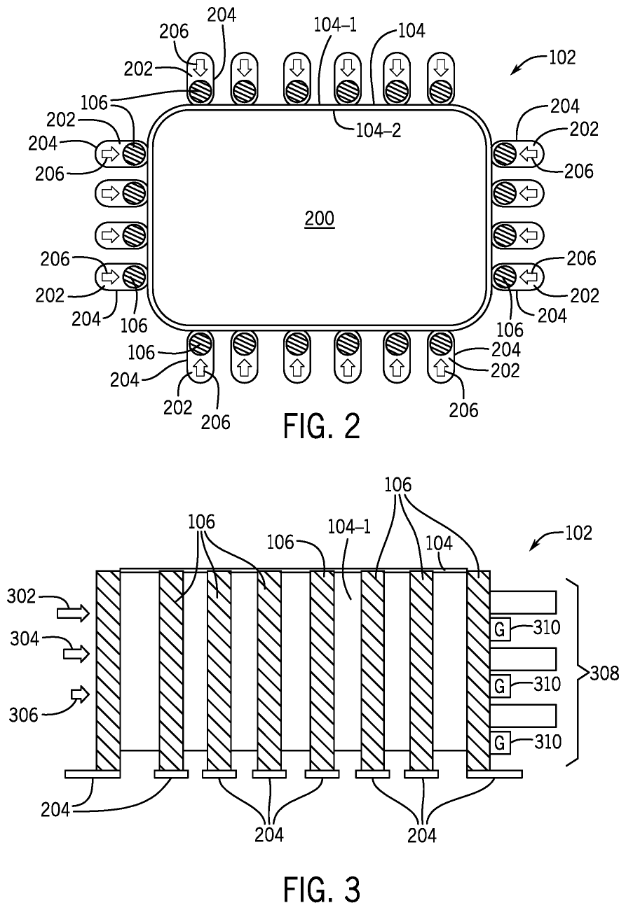

FIG. 2 is a top view of the build module 102, and FIG. 3 is a side view of the build module 102. Pressure application rods 106 are arranged around an outer circumference of the deformable wall 104, and are engaged (i.e., in contact) with multiple points along a side outer surface 104-1 of the deformable wall 104. The inner surface 104-2 of the deformable wall 104 defines an inner chamber 200 of the build module 102, in which the build plate 108 (FIG. 1) is provided to define the workspace 112 (FIG. 1).

As shown in FIG. 2, each of the pressure application rods 106 has a circular cross-section or a cross-section of a different shape. Although FIG. 2 shows each pressure application rod 106 as being solid, it is noted that in further examples, each pressure application rod 106 can be tubular with an inner bore that extends longitudinally along the tubing.

In some examples, one end (e.g., the lower end as represented in FIG. 3) of each pressure application rod 106 is received in a slot 202 of a corresponding guide 204. As shown in FIG. 1, the guides 204 are arranged around the outer circumference of the deformable wall 104. Each guide 204 can be a tight-fitting guide to provide for linear motion of a corresponding pressure application rod 106 in the respective slot 202. The guides 204 are attached to the pressure application rods 106.

Each pressure application rod 106 is slideable along the slot 202 of the corresponding guide 204. Arrows 206 in FIG. 2 show the direction of the lateral forces that can be applied by the respective pressure application rods 106 against the side outer surface 104-1 of the deformable wall 104. Note that the lateral forces applied by the respective pressure application rods 106 along the arrows 206 can be different or at least some can be the same.

The lateral force applied by the pressure application rods 106 against the deformable wall 104 can be constant or can be variable.

FIG. 3 shows arrows 302, 304, and 306 representing respective different lateral forces applied by a pressure application rod 106 against a portion of the deformable wall 104. A larger arrow (302) represents a larger amount of lateral force applied by a portion of the pressure application rod 106 than a smaller arrow (e.g., 306). The different lateral forces 302, 304, and 306 are applied along a length of a pressure application rod 106. In the example shown, a larger lateral force (302) is applied nearer the top of the build module 102, while a lower lateral force (306) is applied nearer the bottom of the build module 102.

In other examples, the same force can be applied along the length of each pressure application rod 106.

FIG. 3 also shows a schematic representation of a load applicator 308 that is able to apply a load against a pressure application rod 106 to cause the pressure application rod 106 to apply lateral forces 302, 304, and 306. For example, the load applicator 308 can include a spring (or multiple springs) to produce the lateral forces 302, 304, and 306 applied by the pressure application rod 106 against the outer surface 104-1 of the deformable wall 104. In other examples, the load applicator 308 can include a motor connected to an arrangement of struts (in some cases at least one of the struts can be spring-loaded) to cause application of the respective lateral forces along a pressure application rod 106. In other examples, other types of load applicators 308 can be used, including electromagnetic load applicators, mechanical load applicators driven by motors, load applicators with cam-shaft mechanisms, and so forth.

In further examples, the load applicator 308 can include strain gauges 310, where each strain gauge 310 is able to measure a representation of the lateral force applied against a portion of a respective pressure application rod 106. Based on measurements of the strain gauges 310, the load applicator 308 can control the amount of lateral force applied by any given portion of a pressure application rod 106 (as depicted in FIG. 2 or 3 or as discussed elsewhere in this disclosure).

In some examples, the load applicator 308 can cause a pressure application rod 106 to apply different lateral forces respective different build cycles. For example, during initial build cycles (when the build plate 108 (FIG. 1) is higher up in the build module 102, a larger lateral force can be applied by a pressure application rod 106. As more build cycles are performed and the build plate 108 (FIG. 1) is lowered in the build module 102, smaller lateral forces can be applied by a pressure application rod 106.

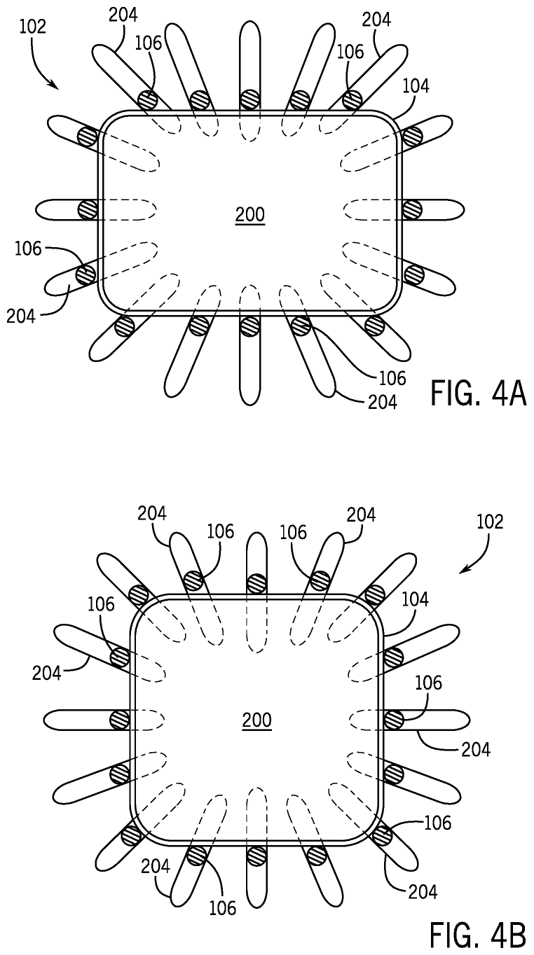

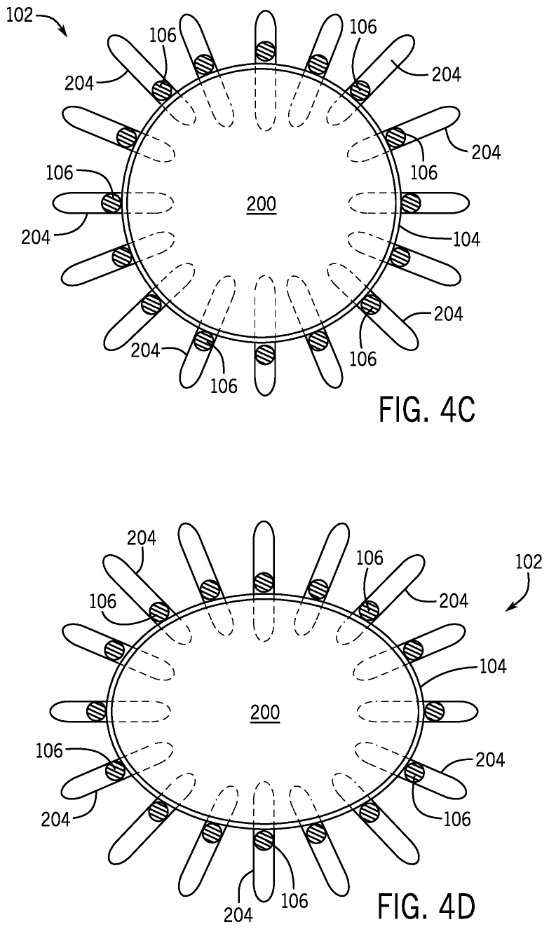

FIGS. 4A-4D show different geometric shapes of the deformable wall 104 as deformed by the pressure application rods 106. FIG. 4A shows the deformable wall 104 with a generally rectangular shape (note that the shape of the deformable wall 104 shown in FIG. 4A is not strictly a rectangle, but rather can have rounded corners).

FIG. 4B shows the deformable wall 104 with a generally square shape as deformed by the pressure application rods 106. FIG. 4C shows the deformable wall 104 with a generally circular shape as deformed by the pressure application rods 106. FIG. 4D shows the deformable wall 104 with an oval shape as deformed by the pressure application rods 106.

It is noted that in FIGS. 4A-4D, the circumference of the deformable wall 104 is substantially the same, even though the geometric shape of the deformable wall 104 differs in FIGS. 4A-4D. Moreover, the area (when viewed from the top) of the inner chamber 200 remains substantially the same in FIGS. 4A-D.

As shown in each of FIGS. 4A-4D, the pressure application rods 106 are slideable along slots of corresponding guides 204. The pressure application rods 106 are moved in specified sequences to achieve the target geometric shapes shown in FIGS. 4A-4D.

Although specific geometric shapes are shown in FIGS. 4A-4D, it is noted that in other examples, other geometric shapes can be achieved by controlling respective movements of the pressure application rods 106.

Although the circumference and the cross-sectional area of the inner chamber 200 of the build module 102 remain substantially constant across the different geometric shapes shown in FIGS. 4A-4D (the circumference and cross-sectional area remain within some specified tolerance of one another for the different geometric shapes), the aspect ratio of the build module 102 changes for the different geometric shapes. The change in aspect ratio among the different geometric shapes can be used to accommodate target 3D objects of different sizes. For example, a target 3D object that is generally rectangular in shape can be accommodated in the build module 102 with the geometric shape shown in FIG. 4A. In other examples, target 3D objects with a square shape, a circular shape, and an oval shape can be accommodated in the build module 102 having the geometric shapes shown in FIG. 4B-4D, respectively.

The ability to change shapes of the build module 102 to build different target 3D objects allows for more efficient usage of a build material, by reducing the amount of wasted build material that is not used in build cycles of a build operation.

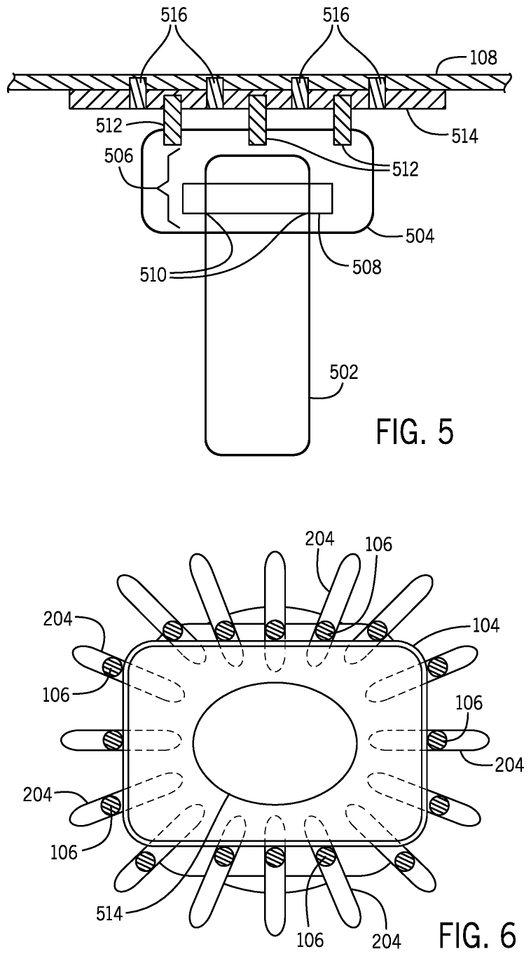

FIG. 5 is a side view of an assembly that includes a platform base 502, a mounting base 504, and a release mechanism 506 that releasably attaches the mounting base 104 to the platform base 502. The assembly shown in FIG. 5 is useable in an additive manufacturing machine. In some examples, the release mechanism 506 can include a rod 508 that is insertable through openings 510 in the platform base 502. A user removing the rod 508 from the openings 510 allows for the mounting base 504 to be quickly released from the platform base 502.

As further shown in FIG. 5, the mounting base 504 is attached by an attachment mechanism 512 (which can include bolts, for example) to a mounting cap 514. The mounting cap 514 has a generally flat upper surface to engage the build plate 108. Mounting elements 516 (e.g., bolts) can be used to attach the mounting cap 514 to the build plate 108.

The assembly of the mounting base 504, mounting cap 514, and build plate 108 can be considered to be a platform assembly that can be released from the platform base 502. Once released, a different platform assembly can be attached to the platform base 502. Different platform assemblies can employ build plates 108 of different geometric shapes, for use in corresponding build modules of the different geometric shapes, such as those shown in FIGS. 4A-4D.

During operation of the additive manufacturing machine, the platform base 502 can be raised up and down to change the height of the build plate 108.

FIG. 6 is a top view of a build module 102 with the platform mounting cap 514 shown inside the inner chamber of the build module 102. FIG. 6 shows the mounting cap 514 without the build plate 108 attached. In the example of FIG. 6, the mounting cap 514 has a generally oval shape. In a different example, the mounting cap 514 can have a different shape, such as a rectangular shape, a square shape, and so forth.

The size of the mounting cap 514 is small enough such that it fits inside a general profile defined by the radially innermost ends of the guides 204.

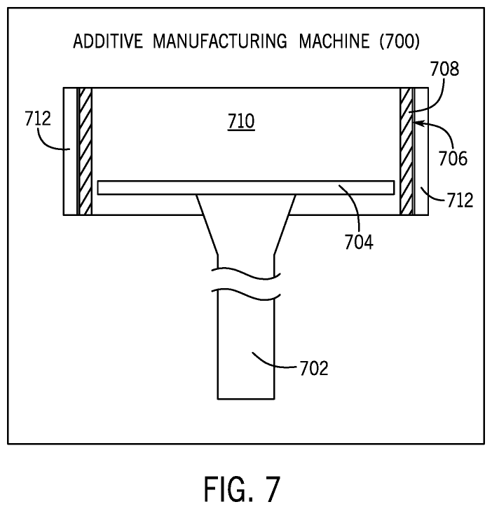

FIG. 7 is a block diagram of an additive manufacturing machine 700 including a platform base 702 to support a build plate 704 onto which build material is to be provided. The additive manufacturing machine 700 also includes a build module 706 that includes a deformable wall 708 defining a build chamber 710 for receiving the build material during a build operation of the additive manufacturing machine 700. The build module 706 also includes pressure application rods 712 arranged around a circumference of the deformable wall 708 and in contact with a plurality of points of the deformable wall 708, the pressure application rods 712 to deform the deformable wall 708 by applying side forces against the deformable wall 708.

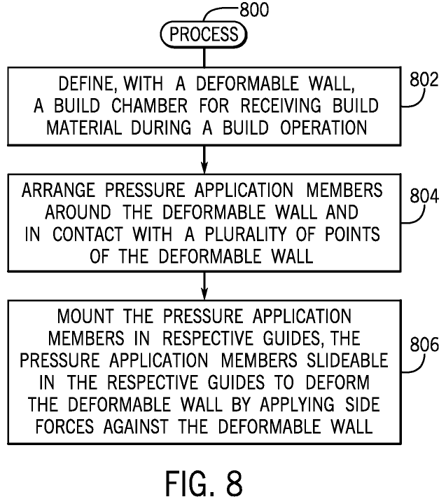

FIG. 8 is a flow diagram of a process 800 of forming a build module for an additive manufacturing machine.

The process 800 includes defining (at 802), with a deformable wall, a build chamber for receiving build material during a build operation. The process 800 further includes arranging (at 804) pressure application members around the deformable wall and in contact with a plurality of points of the deformable wall.

In addition, the process 800 includes mounting (at 806) the pressure application members in respective guides, the pressure application members slideable in the respective guides to deform the deformable wall by applying side forces against the deformable wall.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A build module for an additive manufacturing machine, comprising:
a deformable wall defining a build chamber for receiving build material during a build operation; and
pressure application members arranged around the deformable wall and in contact with a plurality of points of the deformable wall, the pressure application members to deform the deformable wall by applying lateral forces against the deformable wall.

2. The build module of claim 1, wherein the pressure application members comprise pressure application rods.

3. The build module of claim 1, further comprising guides that receive the pressure application members, wherein a pressure application member of the pressure application members received in a corresponding guide of the guides is slideable in the corresponding guide.

4. The build module of claim 1, further comprising a load applicator to apply a load against the pressure application members.

5. The build module of claim 4, wherein the load applicator comprises a variable load applicator to vary the load applied against the pressure application members at different stages of a build operation.

6. The build module of claim 4, wherein the load applicator comprises a variable load applicator to vary the load applied at different points along a length of a pressure application member.

7. The build module of claim 1, wherein the deformable wall is non-welded.

8. The build module of claim 1, wherein the pressure application members are moveable to change a shape of the deformable wall between different geometric shapes.

9. The build module of claim 8, wherein the different geometric shapes change an aspect ratio of an inner chamber of the build module.

10. The build module of claim 8, wherein a circumference and area of an inner chamber of the build module remain substantially constant as the deformable wall changes between the different geometric shapes.

11. The build module of claim 1, further comprising a releasable platform assembly to releasably mount, in the build chamber of the build module, a build plate selected from a plurality of build plates of different shapes.

12. An additive manufacturing machine comprising:
a platform base to support a build plate onto which build material is to be provided; and
a build module comprising:
a deformable wall defining a build chamber for receiving the build material during a build operation of the additive manufacturing machine; and
pressure application rods arranged around a circumference of the deformable wall and in contact with a plurality of points of the deformable wall, the pressure application rods to deform the deformable wall by applying side forces against the deformable wall.

13. The additive manufacturing machine of claim 12, wherein the build module further comprises:
guides that receive the pressure application rods, wherein a pressure application rod of the pressure application rods received in a corresponding guide of the guides is slideable in the corresponding guide.

14. A method of forming a build module for an additive manufacturing machine, comprising:
defining, with a deformable wall, a build chamber for receiving build material during a build operation;
arranging pressure application members around the deformable wall and in contact with a plurality of points of the deformable wall; and
mounting the pressure application members in respective guides, the pressure application members slideable in the respective guides to deform the deformable wall by applying side forces against the deformable wall.

15. The method of claim 14, wherein the deforming of the deformable wall by the pressure application members is to cause a change in shape of the deformable wall between different shapes.
